(19) United States
(12) Patent Application Publication
(10) Pub. No.: US 2005/0114590 A1
(43) Pub. Date: May 26, 2005

(54) Drive controller user interface

(76) Inventor: Jan Klier, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/723,037

(22) Filed: Nov. 26, 2003

(51) Int. Cl. G06F 12/00

(52) U.S. Cl. 711/111

(57) ABSTRACT

Drive controller interface systems and methods. An exemplary system comprises a data access drive operable to read and write computer-readable data on storage media, and a drive controller provided at the data access drive. Computer-readable program code is provided in computer-readable storage at the data access drive, the computer-readable program code for generating drive information and user interface rendering data. A user interface module outputting the drive information via a user interface in accordance with the user interface rendering data.

### TECHNICAL FIELD

This invention relates to drive controllers in general, and more specifically, to drive controller user interfaces in automated storage systems.

### BACKGROUND

Storage systems are commonly used to store large volumes of data on removable storage media, such as magnetic tape cartridges and optical storage media, to name only a few. Such storage systems may include a number of storage locations for the storage media and one or more drives to perform data access operations on the storage media.

It is often desirable to view the drive configuration and performance values in order to assist in detecting and correcting problems with the drive. However, the display and keypad typically provided with these storage systems do not allow the user to configure or monitor diagnostic information for the data access drive(s).

Although software may be provided (e.g., on a network computer) that allows the user to view and configure the drives, the user has to install the software before it can be used. In addition, the software may not be compatible with the user's operating system. Furthermore, the software interfaces with the drive(s) via the same data path that is used for data operations (e.g., backup and restore operations) and therefore the software may interfere with these data operations.

### SUMMARY

An exemplary system comprises a data access drive operable to read and write computer-readable data on storage media, and a drive controller provided at the data access drive. Computer-readable program code is provided in computer-readable storage at the data access drive, the computer-readable program code for generating drive information and user interface rendering data. A user interface module outputting the drive information via a user interface in accordance with the user interface rendering data.

An exemplary method comprises: receiving drive information and user interface rendering data from a drive controller at a data access drive, and outputting the drive information in a user interface in accordance with the user interface rendering data.

In an automated storage system having a graphical user interface including a display and a user interface selection device, an exemplary method of providing and selecting from the display, comprising: receiving drive information and user interface rendering data by a drive controller at a data access drive in the automated storage system, and displaying the drive information in an application window in accordance with the user interface rendering data.

### BRIEF DESCRIPTION OF THE DRAWINGS

FIG. 1 is a schematic illustration of an exemplary implementation of a storage system;

FIG. 2 is a functional diagram illustrating an exemplary implementation of a user interface for a drive controller;

FIG. 3 is an illustration of an exemplary graphical user interface for a drive controller; and

FIG. 4 is a flowchart of exemplary operations to implement a user interface for a drive controller.

### DETAILED DESCRIPTION

Briefly, an implementation of the invention generates both the drive information and associated user interface information in the drive controller. The drive information and user interface information are generally platform independent. Therefore, a user can view the drive information in a uniform manner on different types of systems (e.g., at a display provided with the storage system itself or optionally on a separate computer display). Furthermore, by generating this information in the drive controller, the data paths of the system are not significantly impacted. This and other implementations are described in more detail below with reference to the figures.

Exemplary System

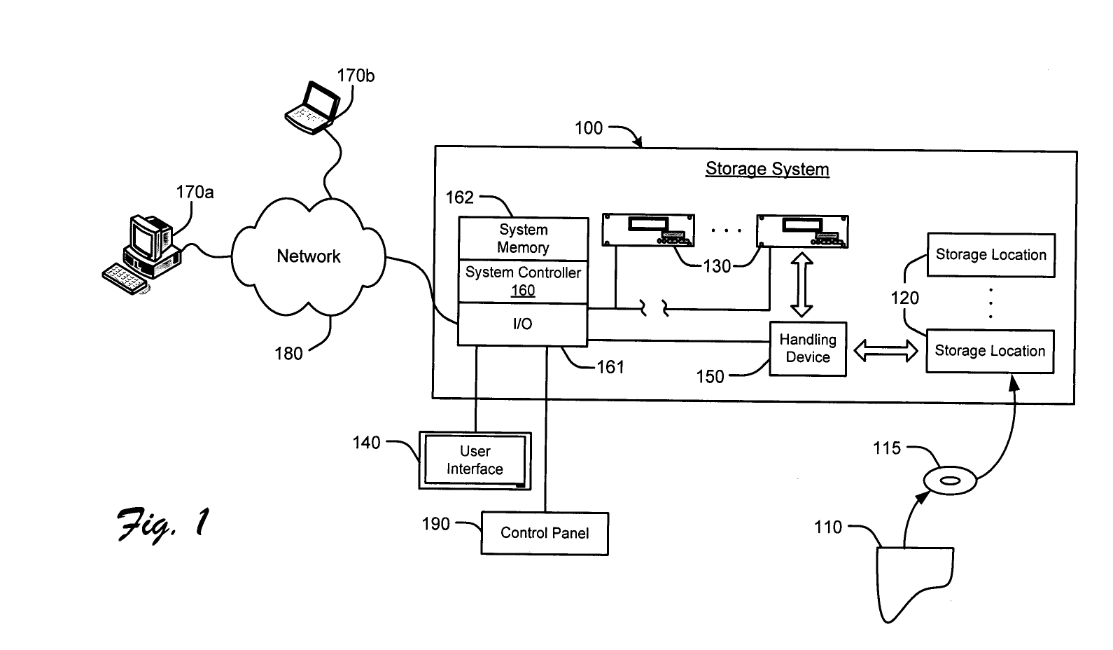

Referring to FIG. 1, an exemplary implementation of an automated storage system 100 (hereinafter generally referred to as a “storage system”) is shown as it may be used to access data 110 on one or more storage medium 115. The storage medium 115 may include magnetic data cartridges, optical media, and hard disk storage, to name only a few examples.

Storage system 100 may include one or more libraries (not shown) configured to store the storage medium 115, e.g., in storage locations 120. The libraries may be modular (e.g., configured to be stacked one on top of the other and/or side-by-side), allowing the storage system 100 to be readily expanded.

The storage system 100 may also include one or more data access drives 130 for read and/or write operations on the storage medium 115. In one exemplary implementation, each library in the storage system 100 is provided with at least one data access drive 130. However, in other implementations data access drives 130 do not need to be included with each library.

One or more media handling devices 150 may also be provided for transporting the storage medium 115 in the storage system 100. Media handling devices 150 are generally adapted to retrieve storage medium 115 (e.g., from one of the storage locations 120), transport the storage medium 115, and eject the storage medium 115 at an intended destination (e.g., data access drive 130). Various types of media handling devices 150 are readily commercially available, and embodiments of the present invention are not limited to any particular implementation. In addition, such media handling devices 150 are well known and further description is not needed to fully understand or to practice the invention.

Before continuing, it is also noted that the storage system 100 may include any of a wide range of other components that are now known or that may be developed in the future. In addition, the storage system 100 is not limited to any particular configuration. For example, the number of storage locations 120, media handling devices 150, and data access drives 130 provided in the storage system 100 may depend upon various design considerations. Such considerations may include, but are not limited to, the desired storage capacity and frequency with which the computer-readable data 110 is accessed. Still other considerations may include, by way of example, the physical dimensions of the overall storage system 100 and/or its components. Consequently, implementations in accordance with the invention are not to be regarded as being limited to use with any particular type or configuration of storage system 100 or to any particular components.

Storage system 100 may also include a system controller 160 to control a variety of operations, such as, e.g., media handling, inventory, and data handling operations. An exemplary system controller may include a processor (or processing units) and control software and/or firmware. The system controller 160 may also include input/output (I/O) connections 161 for data transfer with other system devices (e.g., data access devices 130, media handling device 150) and/or network computers 170a, 170b connected over a network 180.

The system controller processes computer-readable data signals, for example, embodied in one or more carrier waves. Computer-readable data signals may be sent to and/or received from system memory 162, one or more of the network computers 170a, 170b, and/or a control panel 190 provided with the storage system 100 (e.g., a keypad and display, or a direct-linked computer). Computer-readable data signals may also be used for communicating with media handling device 150 (e.g., for transport operations) and with drive controller(s) for data access drives 130 (e.g., for read and/or write operations).

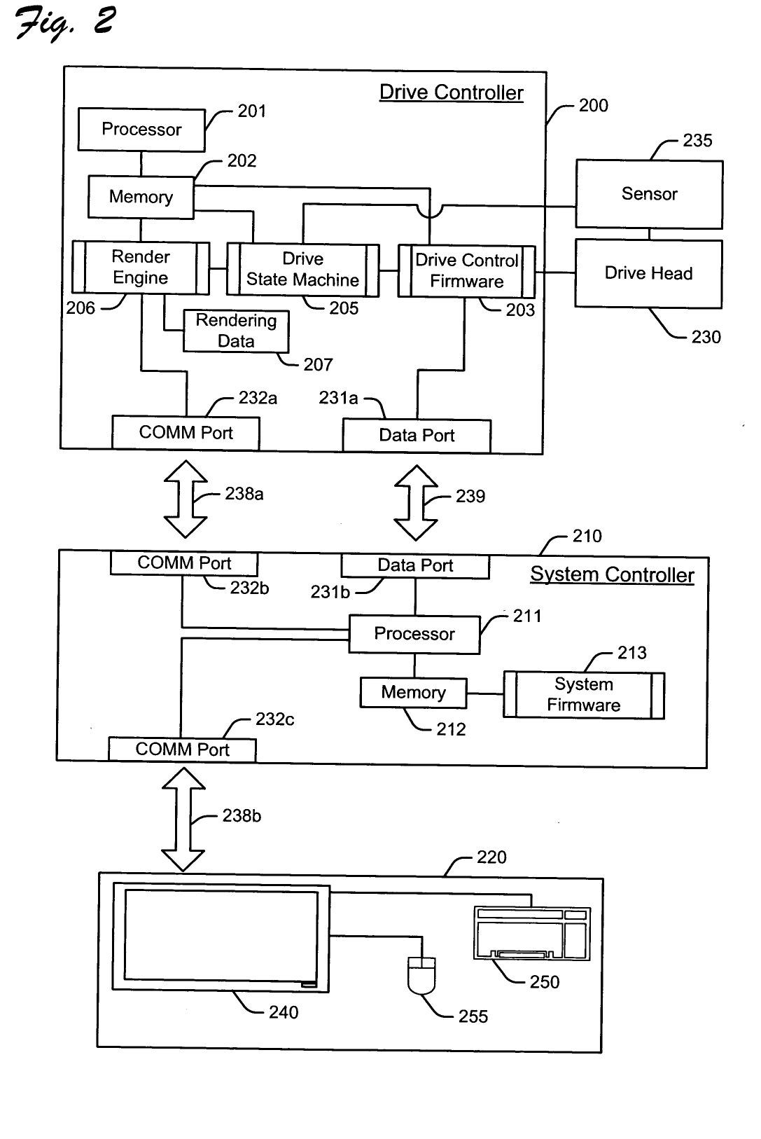

FIG. 2 is a functional diagram illustrating in more detail an exemplary implementation of a user interface for a drive controller. A drive controller 200 is linked to a system controller 210, which is linked to a user interface module 220. Drive controller 200 may retrieve drive information, for example, from memory 202, drive head 230, or sensor devices 235 (e.g., a temperature sensor), or any of a variety of other sources for the data access drive.

Briefly, the drive information may be output at the user interface module 220 in accordance with user interface rendering data (e.g., at display 240). In addition, input may be received at the user interface, for example from keyboard 250 or mouse 255. The input is received at drive controller 200 and may be used, e.g., to configure the data access drive. Updated drive information is then output at the user interface module 220.

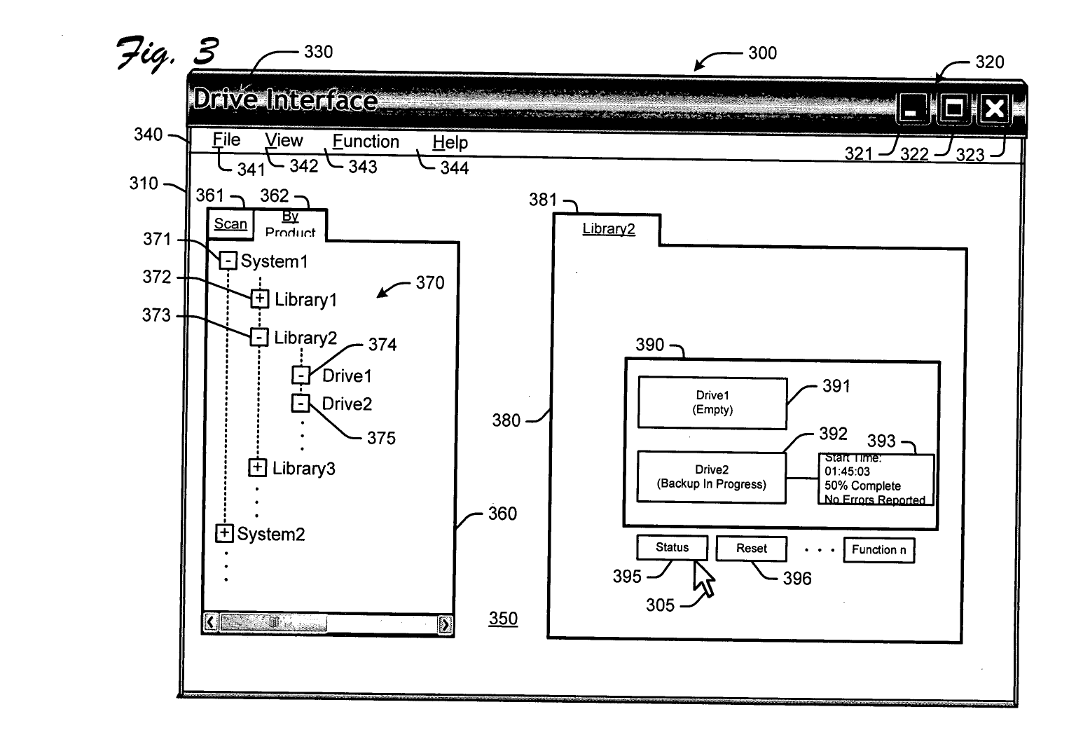

Before continuing, it is noted that drive information is not limited to any particular type or format of information. Drive information may include, without limitation, the drive status (e.g., empty, backup operation in progress), drive log data (e.g., duration of backup operations), drive operating parameters (e.g., read/write speeds), error rate, and drive temperature. Exemplary drive information 393 is shown in FIG. 3 for purposes of illustration.

It is also noted that drive controller 200 may be linked to system controller 210 in any suitable manner, including via a direct and/or network connection. In an exemplary implementation, drive controller 200, system controller 210, and user interface module 220 may be linked via I/O ports. I/O ports may include data ports 231a, 231b (e.g., a SCSI interface) and communications or COMM port 232a, 232b and 235c (e.g., a serial interface). Data ports 231a, 231b may be used for data transfer signals (e.g., between drive controller 200 and system controller 210) and COMM ports 232a, 232b may be used for control signals. Communications between the drive controller 200 and the user interface module 220 may be via a communication path (e.g., illustrated by arrows 238a, 238b) established between COMM ports 232a, 232b, and 235c, and is separate from a data path (e.g., illustrated by arrows 239) established between data ports 231a, 231b.

Drive controller 200 may be implemented as a processor (or processing units) 201 and computer-readable storage or memory 202. For example, the drive controller 200 may be implemented in an integrated circuit (IC) or computer board. Drive controller 200 is provided at the data access drive for drive operations. For example, drive controller 200 may include drive control firmware 203 to control operation of the drive head 230 (e.g., to start and stop read/write operations) and data transfer between the drive controller 200 and the system controller 210 (e.g., via data path 239).

Drive controller 200 may also include a drive state machine 205 and a render engine 206 that may be implemented to retrieve drive information and generate output for user interface module 220. Briefly, drive state machine 205 retrieves drive information from memory 202, drive head 230, or any of a variety of sensor devices 235. Render engine 206 may provide rendering data 207 (e.g., formatting and graphics, as shown in FIG. 3) for outputting the drive information at the user interface module 220.

Drive state machine 205 may be implemented in firmware stored in memory 202 and executed by processor (or processing units) 201. Drive state machine 205 determines the state of the data access drive. For example, drive state machine 205 may determine whether the data access drive is empty or whether a backup/restore operation is in progress. Drive state machine 205 may also be used to request a change of state from the drive control firmware 203, for example, when a “Start” or “Stop” command is received from the user interface module 220.

Render engine 206 may also be implemented in firmware stored in memory 202 and executed by processor (or processing units) 201. Render engine 206 formats the drive information for output at user interface module 220. Render engine 206 may use predefined objects or data structures (e.g., defined by the rendering data 207) to format the drive information.

Render engine 206 also associates the user interface output with program code for controlling various operations at the data access drive. These associations may also be included with the rendering data 207. For example, render engine 206 may associate a “Status” button (e.g., button 395 in FIG. 3) with program code for retrieving the drive status from drive state machine 205. As another example, render engine 206 may associate a “reset” button (e.g., button 396 in FIG. 3) with program code for returning the data access drive to its default configuration.

Before continuing, it is noted that exemplary drive controller 200 is shown and described herein merely for purposes of illustration and is not intended to limit the drive controller 200 to any particular implementation. For example, drive state machine 205 and render engine 206 do not need to be provided as separate functional components. In addition, other functional components may also be provided and are not limited to a render engine and a drive state machine.

System controller 210 is operatively associated with one or more drive controllers 200, e.g., via communication path 238a and data path 239. As described above, system controller 210 may be implemented as a processor (or processing units) 211 and computer-readable storage or memory 212. For example, the system controller 210 may be implemented in an integrated circuit (IC) or computer board. System controller 210 may include system firmware 213 stored in memory 212 and executed by processor (or processing units) 211. System firmware may be provided to control any of a variety of operations in the storage system, such as without limitation, operating the handling device to retrieve and transport storage media.

System controller 210 is also operatively associated with a user interface module 220, for example, via a network or direct connection (illustrated by communication path 238b). Accordingly, system controller 210 may be implemented to provide the user interface rendering generated at the drive controller 200 to the user interface module 220 and to provide input (e.g., control instructions) from the user interface module 220 to the drive controller 200.

User interface module 220 may be implemented on a dedicated I/O device, such as a dot matrix display device with keypad provided as part of the storage system itself. Alternatively, user interface module 220 may be implemented, for example, in a windows operating environment (e.g., Microsoft Corporation's WINDOWS® operating system) on a personal or network computer system. User interface module 220 may include a display 240, and optionally a keyboard 250, a mouse 255, speakers (not shown), a printer (not shown), and other I/O devices. In any event, the invention is not to be limited to either implementation.

In operation, user interface module 220 outputs the drive information in accordance with the user interface rendering data generated at the drive controller 200. For example, the drive information may be displayed in a graphical user interface (see e.g., FIG. 3). In another exemplary implementation, user interface module 220 may include a multimedia presentation including, e.g., audio and visual output.

FIG. 3 is a diagrammatic illustration of an exemplary user interface for a data access drive in a storage system. The exemplary user interface is implemented as a graphical user interface 300, although other implementations are also possible. For example, in another implementation (not shown), the user interface may be implemented using the physical keypad and display provided on a library of the storage system.

Graphical user interface 300 is associated with an interface application (e.g., state machine 205 and render engine 206 in FIG. 2). The user may launch the graphical user interface 300 in a customary manner, for example, by clicking on an icon, selecting the program from a menu, or pressing a button on a keypad.

The graphical user interface 300 supports user interaction through common techniques, such as via a pointing device (e.g., mouse, style), keystroke operations, or touch screen. By way of illustration, the user may make selections using a mouse to position a graphical pointer 305 and click on a label or button displayed in the graphical user interface 300. The user may also make selections by entering a letter for a menu label while holding the ALT key (e.g., “ALT+letter” operation) on a keyboard (e.g., keyboard 250 in FIG. 2). In addition, the user may use a keyboard to enter command strings (e.g., in a command window).

The graphical user interface 300 is displayed for the user in a window, referred to as the “application window” 310, as is customary in a windowing environment. The application window 310 may include customary window functions 320, such as a Minimize Window button 321, a Maximize Window button 322, and a Close Window button 323. A title bar 330 identifies the application window (e.g., “Drive Interface”). The application window 310 may also include a customary menu bar 340 having an assortment of pull down menus 341-344 (e.g., labeled “File”, “View”, “Function”, and “Help”). For example, the user may select a print function (not shown) from the “File” menu 341.

Application window 310 also includes an operation space 350. Operation space 350 may include one or more graphics for displaying output and/or facilitating input from the user. Graphics may include, but are not limited to, subordinate windows, dialog boxes, icons, text boxes, buttons, and check boxes. Exemplary operation space 350 is shown having subordinate windows, such as, e.g., a device selection window 360 and a drive window 380.

Exemplary device selection window 360 displays data access devices that are available through the graphical user interface 300. The user may select a menu tab in the device selection window 360 to identify a data access device. For example, the user may select the “Scan” menu tab 361 to automatically scan all connections for available data access devices (e.g., on a local area network). Alternatively, the user may select the “By Product” menu tab 362 to manually identify a data access device using a file tree.

For purposes of illustration, the user selected the “By Product” menu tab 362 in FIG. 3. Accordingly, a file tree 370 is displayed in the device selection window 360. Nodes may identify storage systems, libraries, and drives. The user may expand one or more parent nodes in the file tree 370 to view child nodes. A closed node may be displayed with a “+” symbol and an expanded node may be displayed with a “−” symbol. In FIG. 3 for example, parent node 371 (e.g., System1) is expanded to show child nodes 372, 373 (Library1, Library2) belonging to the parent node 371. In addition, node 373 is expanded to show child nodes 374, 375 (Drive1, Drive2) belonging to node 373.

Other implementations for selecting data access devices are also contemplated as being within the scope of the invention. For example, the user may identify the data access device by a network address entered in a text box (not shown).

Exemplary drive window 380 displays drive information for the data access drive(s) selected in device selection window 360. In FIG. 3, for example, drive window 380 displays drive information for data access drives in “Library2”. Title tab 381 may identify the selected system, library, or data access drives.

Drive window 380 may include a display box 390. Display box 390 includes graphics renderings of the selected data access drives 391, 392. Drive information 393 may also be displayed for the data access drives (e.g., “empty” and “backup in progress”).

In addition, drive window 380 may also include one or more function buttons. Without limitation, function buttons may include a status button 395 and a reset button 396, although other function buttons may also be provided (e.g., the “Function n” button shown in FIG. 3). The user may select these buttons to perform various functions for retrieving drive information for the data access drive(s) and/or configuring the data access drive(s). In FIG. 3, for example, the user has selected, using pointer 305, status button 395 to display the current status of the data access drives (e.g., drive information 393).

Table 1 includes a sample list of functions that can be performed upon selection in the graphical user interface 300. This sample list is merely illustrative of some of the functions available via the graphical user interface 300, and is by no means exhaustive. It will be readily appreciated by those having ordinary skill in the art after having become familiar with the teachings of the invention that yet other functions may also be readily implemented.

TABLE 1
Exemplary Functions

| Function | Description |
|---|---|
| Status | Displays current status of drive |
| | (e.g., reading, writing, paused) |
| Backup | Start a backup operation |
| Restore | Start a restore operation |
| Pause | Temporarily suspend operation |
| Resume | Resume a paused operation |
| Reset | Return drive to default configuration |
| Interrupt | Stop current operation |
| Eject | Remove media from a drive |
| History | Display operation/event log |
| Statistics | Display statistics log (e.g., usage, speed, error rate) |
| Configure | Display command prompt |
| Refresh | Update current display |
| Connect | Make drive available |
| Disconnect | Make drive unavailable |

Although not shown in FIG. 3, it is noted that the application window 310 may also include other components. These components may include, without limitation, a status bar to indicate the status of the user interface (e.g., connecting, searching for devices, etc.). Likewise, text and/or graphics displayed in the application window 310 may be highlighted when corresponding features are available or active, and may be “grayed out” when corresponding features are unavailable or inactive.

Exemplary Operations

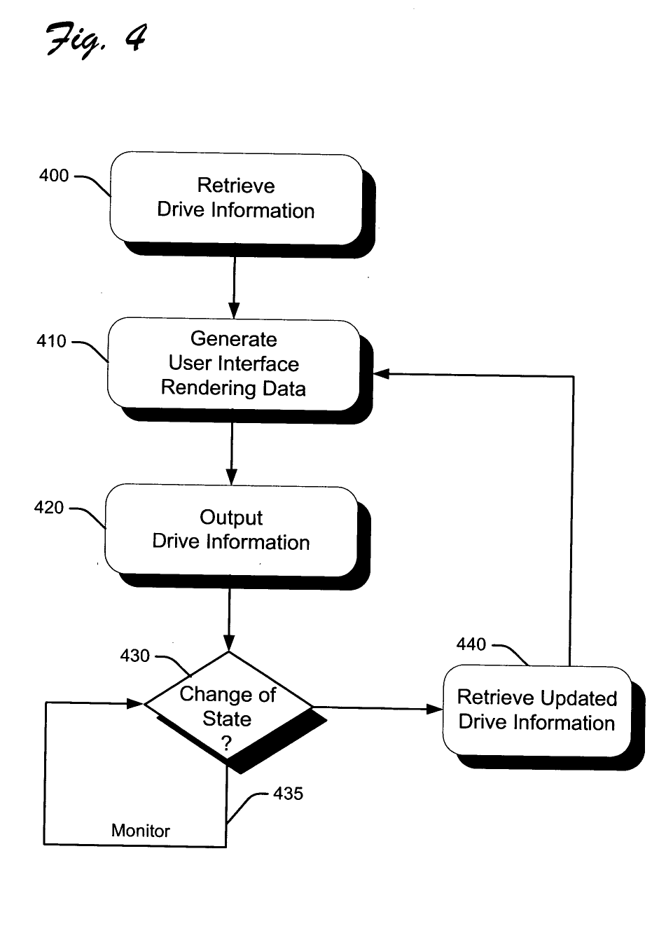

FIG. 4 is a flowchart illustrating exemplary operations to implement a user interface for a drive controller. In operation 400, the drive controller retrieves drive information. As discussed above, drive information may be retrieved from any of a variety of sources (e.g., memory 202, drive head 230 and/or sensors 235 in FIG. 2). In operation 410, user interface rendering data is generated. In an exemplary implementation, the user interface rendering data and drive information are generated at the drive controller. In other implementations, however, the user interface rendering data may be generated and/or modified at the system controller. The drive information is output in operation 420 in accordance with the user interface rendering data. For example the drive information may be displayed in a graphical user interface (see e.g., FIG. 3). Alternatively, the output may include a multimedia presentation.

In operation 430, the drive controller monitors the data access device(s) for a change of state. The data access drive may change state in response to user input received at the user interface, in response to starting or stopping a read/write operation, or if there is a failure at the data access drive, to name only a few examples. The monitoring operation 430 continues if the drive state is unchanged, as illustrated by loop 435. If the drive state changes, updated drive information is retrieved in operation 440. The operations return to operation 410 to generate user interface rendering data for the updated drive information. The updated drive information may be output at the user interface in operation 420 in accordance with the user interface rendering data. In one exemplary implementation, the entire user interface is refreshed by generating a new user interface rendering in operation 420. In another exemplary implementation, only portions of the user interface that are affected by the updated drive information are refreshed.

It is noted that the exemplary operations shown and described with reference to FIG. 4 are not intended to limit the scope of the invention to any particular order. In addition, the operations are not limited to the closed loop shown and described in FIG. 4. In other exemplary implementations, the operations may end (e.g., in response to receiving a pause, stop, or reset command). Still other implementations are also contemplated, as will be readily apparent to those skilled in the art after having become familiar with the teachings of the invention.

In addition to the specific implementations explicitly set forth herein, other aspects and implementations will also be apparent to those skilled in the art from consideration of the specification disclosed herein. It is intended that the specification and illustrated implementations be considered as examples only, with a true scope and spirit of the following claims.

1. An automated storage system comprising:
a data access drive operable to read and write computer-readable data on storage media;
a drive controller provided at the data access drive;
computer-readable program code provided in computer-readable storage at the data access drive, the computer-readable program code for generating drive information and user interface rendering data; and
a user interface module outputting the drive information via a user interface in accordance with the user interface rendering data.

2. The system of claim 1 wherein the computer-readable program code includes a render engine to generate the user interface rendering data.

3. The system of claim 1 wherein the computer-readable program code includes a state machine to retrieve the drive information.

4. The system of claim 1 wherein the drive controller retrieves updated drive information if a data access drive changes state.

5. The system of claim 1 further comprising a communication path established between the drive controller and the user interface module, the drive information and the user interface rendering data provided to the user interface module via the communication path.

6. The system of claim 5 wherein the communication path is established separate from a data path with the drive controller.

7. The system of claim 1 further comprising a communication path established between the drive controller and a system controller and between the system controller and the user interface module, the drive information and the user interface rendering data provided to the user interface module via the communication path.

8. The system of claim 1 wherein the drive information and the user interface rendering data is displayed in a graphical user interface.

9. The system of claim 1 wherein the drive controller retrieves updated drive information based at least in part on input from the user interface module.

10. The system of claim 1 wherein the drive controller receives control instructions from the user interface module.

11. A method comprising:
receiving drive information and user interface rendering data from a drive controller at a data access drive;
outputting the drive information in a user interface in accordance with the user interface rendering data.

12. The method of claim 11 wherein receiving the drive information and the user interface rendering data is via a system controller.

13. The method of claim 11 wherein receiving drive information and user interface rendering data is via a separate communications path.

14. The method of claim 11 further comprising displaying the drive information in a graphical user interface in accordance with the user interface rendering data.

15. The method of claim 11 further comprising determining a drive state of a data access drive, the drive information including the drive state.

16. The method of claim 11 further comprising receiving input at the drive controller from the user interface.

17. The method of claim 16 further comprising outputting updated drive information after receiving input from the user interface.

18. In an automated storage system having a graphical user interface including a display and a user interface selection device, a method of providing and selecting from the display comprising:
receiving drive information and user interface rendering data from a drive controller at a data access drive in the automated storage system; and
displaying the drive information in an application window in accordance with the user interface rendering data.

19. The computer system of claim 18 wherein the method further comprises receiving user input associated with a selection in the application window.

20. The computer system of claim 18 wherein the method further comprises displaying updated drive information in the application window if a drive state changes.
